(19) United States
(12) Patent Application Publication
(10) Pub. No.: US 2021/0206082 A1
(43) Pub. Date: Jul. 8, 2021

(54) 3D PRINTER TO RECEIVE A MATERIAL CARTRIDGE

(71) Applicant: HEWLETT-PACKARD DEVELOPMENT COMPANY, L.P., Spring, TX (US)

(72) Inventors: Jeremy BARRIBEAU, Vancouver, WA (US); David C. HARVEY, Corvallis, OR (US); John ENNIS, Vancouver, WA (US); Adam L. HORNSTEIN, San Diego, CA (US)

(73) Assignee: HEWLETT-PACKARD DEVELOPMENT COMPANY, L.P., Houston, TX (US)

(21) Appl. No.: 16/075,602

(22) PCT Filed: Apr. 21, 2017
(86) PCT No.: PCT/US17/28817

§ 371 Date: Aug. 4, 2018

(51) Int. Cl. B29C 64/307; B29C 64/255; B29C 64/393

(52) U.S. Cl. CPC B29C 64/307; B29C 64/245; B29C 64/393; B29C 64/255

(57) ABSTRACT

A three-dimensional (3D) printer includes a cartridge receiver to receive a material cartridge containing new material for generation of a 3D object. The 3D printer also includes an energy source disposed to expose an indicator on the material cartridge to energy in response to depletion of the new material in the material cartridge to change the appearance of the indicator. The changed appearance of the indicator indicates that the material cartridge no longer contains new material.

### BACKGROUND

Three-dimensional (3D) printing may produce a 3D object. In particular, a 3D printer may add successive layers of material under computer control to produce the 3D object. A 3D printer may receive a 3D printer material cartridge that holds and supplies the material to the 3D printer.

### DESCRIPTION OF THE DRAWINGS

Certain examples are described in the following detailed description and in reference to the drawings, in which:

FIG. 1 is a diagram of a 3D printer in accordance with examples of the present techniques;

FIG. 2 is a diagram of a 3D printer in accordance with examples of the present techniques;

FIG. 3 is a diagram of a 3D printer in accordance with examples of the present techniques;

FIG. 4 is a diagram of a 3D printer in accordance with examples of the present techniques;

FIG. 5 is a block flow diagram of an example method for processing a material cartridge in accordance with examples of the present techniques;

FIG. 6 is a block flow diagram of an example method for processing a material cartridge in accordance with examples of the present techniques; and

FIG. 7 is a block diagram of a computer-readable medium 700 that may contain code to execute the processing of a 3D printer material cartridge in accordance with examples of the present techniques.

### DETAILED DESCRIPTION

Techniques for a 3D printer employing and processing a three-dimensional (3D) printer material cartridge are discussed herein. A 3D printer may form a 3D object from material contained and made available by a material cartridge residing in the 3D printer. The material may be in powder form or other form. The material may be metal, plastic, polymer, glass, ceramic, or other material. Furthermore, as also discussed herein, a material cartridge for a 3D printer may include an indicator, for example, disposed on the exterior surface of the material cartridge. Alternatively, the indicator may be located on an interior surface of the material cartridge and be visible through a clear window. The indicator may include colorant responsive to energy from an energy source located in the 3D printer. The colorant may include ink, pigment, and so on. The energy source may be a light source, a heat source, or both. The indicator may be a message (e.g., text, graphic, etc.) that becomes visible in response to exposure of the indicator colorant to the energy from the energy source.

Some 3D printers that recycle powdered materials in printing may have large, expensive, dedicated machines for storing, processing, and offloading recycled powdered material. The operators of these 3D printers may be highly trained. Alternatively, aftermarket storage buckets may be manually filled with reclaimed powdered material and then labeled by hand. Neither alternative may be desirable, for example, if the 3D printer is to be used by the general public or by lesser skilled users. In contrast, examples of the 3D printer material cartridge discussed herein may be received by a 3D printer designed to be employed by consumers of varying levels of ability.

To process the 3D material cartridge, certain examples of a 3D printer may have one or multiple material cartridge slots. In particular examples, the 3D printer may have two slots: one for “new” material and a second for “recycled” material. Other examples may have more than two slots for material cartridges, or a single slot for a material cartridge. The slots may be cartridge receivers, receptacles, cavities, sleeves, and the like. The new material slot may hold a material cartridge that supplies or otherwise provides material to the 3D printer for printing of the 3D object. In contrast, the recycled material slot may hold a material cartridge that receives material from the 3D printer. The material entering the material cartridge in the recycled material slot may be surplus material left over or otherwise not used in the printing of the 3D object. When a new material cartridge is fully depleted, e.g., when the 3D printer has consumed the contents of the new material cartridge, the material cartridge may be removed by the user and re-purposed for later use in the recycled material slot. In one example, the empty cartridge as a recycled material cartridge in a slot or in a recycled material slot may receive unused powder from the printer during and/or at the conclusion of a print job. The cartridge in the recycled material slot when filled with recycled material may then supply or otherwise provide recycled material for printing of the next print job in some examples. Yet again, other examples of 3D printers may have more than one or two slots for material cartridges.

User removal of the depleted new material cartridge may generally occur soon or immediately after depletion, so the 3D printer can be replenished with more new material. However, the re-installation or re-use of the empty and now “recycled” cartridge may not occur for some time. In other words, the user may retain this recycled cartridge for future use. Indeed, the user may store many of the empty recycled cartridges. The 3D printer may request the user to re-install an empty recycled cartridge in a slot or the recycled material slot.

As indicated, a purpose of the recycled material cartridge and any associated slot in the 3D printer may be to receive excess material from the 3D printer generated during the print process and therefore facilitate clean and contained offloading of excess material generated during the print process. In other words, a recycled cartridge in the single slot or the second slot of the 3D printer may receive excess material from the 3D printer during or after printing. Full recycled cartridges may concurrently supply recycled material or remain in the slot to provide recycled material, or be removed for future use, and the like. Indeed, some of these cartridges full of recycled material may remain in place, removed and stored, or removed and discarded, and so on. Some of these recycled cartridges filled with recycled material may be removed and kept for future use such as when the 3D printer is short of recycled material, e.g., when the recycled material may be mixed with new material and consumed during printing. In certain examples of a 3D printer with only a single slot for a material cartridge, a new material cartridge (e.g., new powder container) may be inserted in the slot and have the contents thereof emptied into, for instance, an internal hopper. The cartridge could then become a recipient for recycled material.

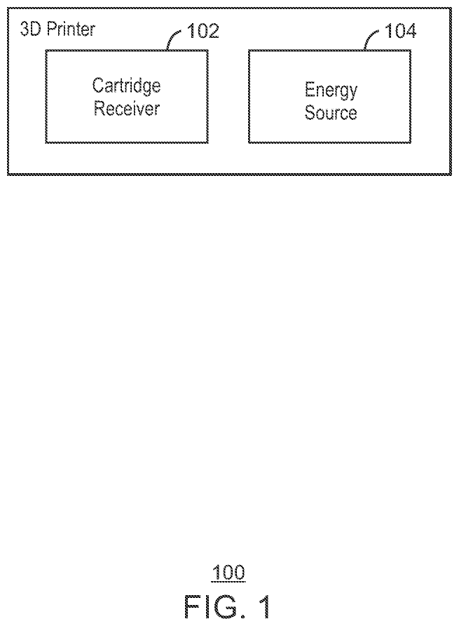

FIG. 1 is a diagram of a 3D printer 100 having a cartridge receiver 102. The cartridge receiver 102 may include a cavity, a receptacle, a sleeve, a slot, or any combinations thereof. The cartridge receiver 102 may receive a material cartridge containing new material for generating of a 3D object. The 3D printer 100 may generate a 3D object from the material. As discussed below, the material cartridge may include an indicator responsive to an energy source 104 of the 3D printer 100.

The new material in the material cartridge inserted into the cartridge receiver 102 may include powder. The powder may be plastic, polymer, metal, ceramic, glass, and so forth. In some examples, the printer 102 may feed the contents of the material cartridge to an internal vessel (not shown), which feeds a build chamber or build platform of the 3D printer 100. The internal vessel of the 3D printer 100 may be a hopper, bin, container, etc.

Moreover, the 3D printer 100 may provide for the material cartridge in the cartridge receiver 102 to receive recycled material from the 3D printer. For example, excess powder from a build chamber of the 3D printer may be transported to the material cartridge. Recycled material may be surplus material left over or otherwise unused in the printing of the 3D object. Recycled material may also be referred to as reclaimed material. The 3D printer 100 may operate such that the cartridge in the cartridge receiver 102 either makes available material for printing or receives recycled material at different times, or both are performed simultaneously.

As mentioned, the material cartridge may include an indicator, such as on an exterior or interior surface of the material cartridge. The energy source 104 may be disposed in the 3D printer 100 such that the indicator may be exposed to energy in response to depletion of material or new material in the material cartridge. The energy provided by the energy source 104 may react with the indicator. After reaction, the indicator may indicate that the cartridge is depleted.

The energy source 104 may be a light source, a heat source, or both. For example, the energy source 104 may be a light source such as a light emitting diode (LED), a halogen light, a fluorescent light, a mercury-arc light, or any combination thereof. If the energy source 102 is an LED, the energy may be ultraviolet light. The 3D printer 100 may include a controller that detects (e.g., via a sensor or calculation) the depletion of new material in the material cartridge and activates the energy source 104 in response to the depletion. In some examples, the controller may be a processor of a computing system of the 3D printer 100.

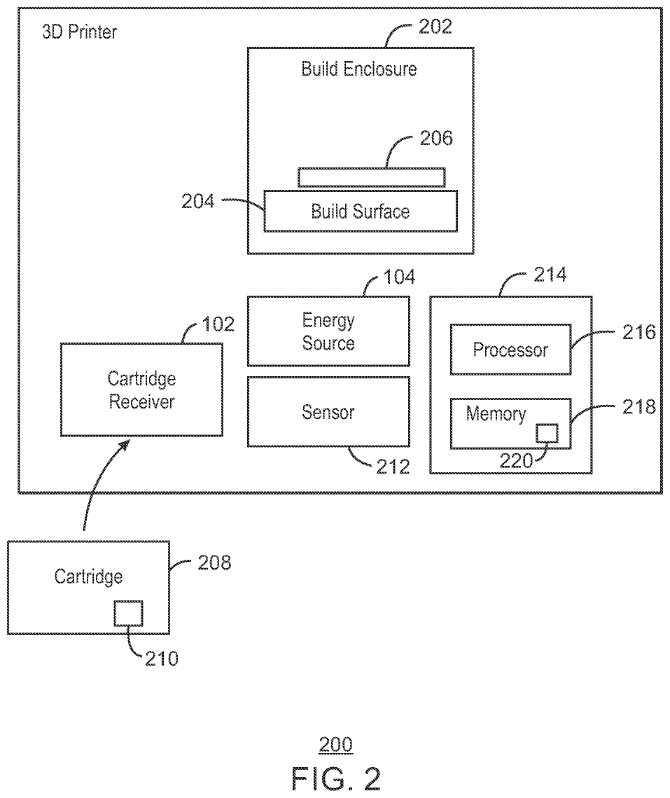

FIG. 2 is a diagram of a 3D printer 200. As in FIG. 1, the 3D printer 200 includes a cartridge receiver 102 and an energy source 104. The 3D printer 200 may include a build enclosure 202 where generating of the 3D object occurs. The build enclosure 202 may include a build surface 204 on which printing takes place. The 3D printer 200 may form the 3D object 206 on the build surface 204 with powder or new powder from a material cartridge 208 inserted into the cartridge receiver 102. The material cartridge has an indicator 210. The indicator 210 may be on an external or internal surface of the material cartridge 208. For example, the indicator may be printed or formed directly on the exterior surface of the cartridge 208, or on a label applied to the exterior surface of the cartridge 208. In other examples, the indicator may be located on an internal surface of the material cartridge and be visible through a clear window. The indicator 210 may be responsive to energy from the energy source 104.

The 3D printer 200 may form the 3D object 206 layer-by-layer using material or new material that includes powder. Again, the powder may be plastic, polymer, metal, ceramic, or glass, or any combinations thereof.

The 3D printer 200 may include a sensor 212 to detect depletion of the material or new material in the material cartridge 208. The sensor 212 may be, for example, a load cell. Other types of sensors 212 may be employed. The 3D printer 200 may also detect the depletion of material or new material in the material cartridge 208 using the rate at which the material or new material is withdrawn from the material cartridge 208. In some examples, the 3D printer 200 may compare the weight of the material cartridge 208 from a load cell as a sensor 212 to the cumulative rate of discharge of material or new material from the material cartridge 208 to give a dual confirmation of depletion.

The 3D printer may include a computer system 214 having a processor 216 and memory 218. The hardware processor 216 may be a microprocessor, central processing unit (CPU), and the like. The processor 216 may be one or more processors, and may include one or more cores. The memory 218 may include volatile memory such as random access memory (RAM), cache, and the like. The memory 318 may include non-volatile memory such as a hard drive, read only memory (ROM), and so forth. The computer system 214 may include code 220 (e.g., instructions, logic, etc.) stored in the memory 218 and executed by the processor 216 to direct or facilitate various techniques discussed herein with respect to processing and handling of a material cartridge 208.

For example, the computing system 214 via the code 220 executed by the processor 216 may determine that the material cartridge is depleted or substantially depleted based on input from the sensor 212 and based on input or data of the material discharge rate from the material cartridge 208. In response to the determined depletion, the computing system 214 via the code 220 executed by the processor 216 may activate (e.g., turn on) the energy source 104 to expose the indicator 210 on or in the material cartridge 208 to energy. The energy may be light or heat, or other form of energy. The exposure of the indicator 210 to the energy may activate the indicator 210. Indeed, the indicator 210 may be responsive or react to the energy. In some examples, a message in the indicator 210 becomes visible in response to the exposure of the indicator 210 to the energy. The message may note that the cartridge 208 is depleted. In on example, the message becoming visible is irreversible.

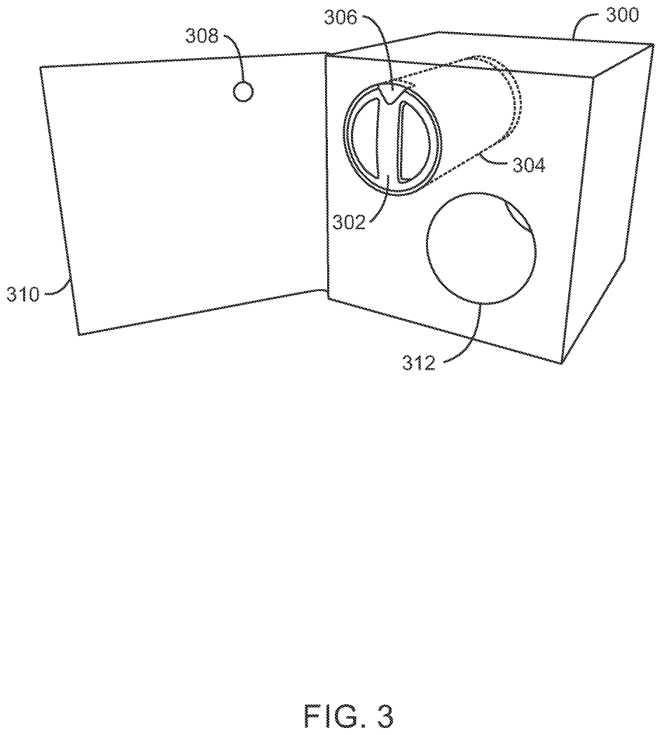

FIG. 3 is a diagram of a 3D printer 300 that receives a material cartridge 302. Only a portion of the 3D printer 300 is depicted for clarity. The 3D printer 300 may include a first slot 304 that accepts the material cartridge 302 containing new material. The 3D printer 300 may receive new material from the material cartridge 302 with the material cartridge 302 positioned in the first slot 304. Indeed, in operation, as the 3D printer 300 generates a 3D object from material including new material, the cartridge 302 in the first slot 304 makes available the new material to the 3D printer 300.

As mentioned, an indicator 306 may be printed on an external or internal surface of the material cartridge 302. The indicator 306 may be invisible because the indicator has not yet been exposed to energy from the energy source 308 (e.g., the material cartridge 302 contains new material for use in 3D printing). The 3D printer 300 includes the energy source 308 (e.g., light source, heat source, etc.) to expose the indicator 306 to energy (e.g., light, heat, etc.) when the cartridge 302 in the first slot 304 becomes depleted of material.

FIG. 3 shows the 3D printer 300 with a front 310 (e.g., door) open. In the illustrated example, when the front 310 is closed, the energy source 308 may be brought into proximity or pointed in the direction of the indicator 306. Thus, with the front 310 closed, and the energy source 308 activated (e.g., in response to depletion of the material cartridge 302), the 3D printer 300 may expose the indicator 306 to the energy generated or provided by the energy source 308. The colorant in the indicator 306 becomes visible (e.g., irreversibly visible) once the indicator 306 is exposed to the energy. The visible indicator may include text or symbols that indicate that the material cartridge 302 is depleted of new material and is designated to receive recycled material.

The 3D printer 300 may further include a second slot 312. The second slot 312 may accept the material cartridge 302 after the material cartridge 302 has been depleted of new material and is available to receive recycled material. The second slot 312 may also receive another material cartridge 302 containing recycled material. Moreover, a material cartridge 302 may receive recycled material from the 3D printer 300.

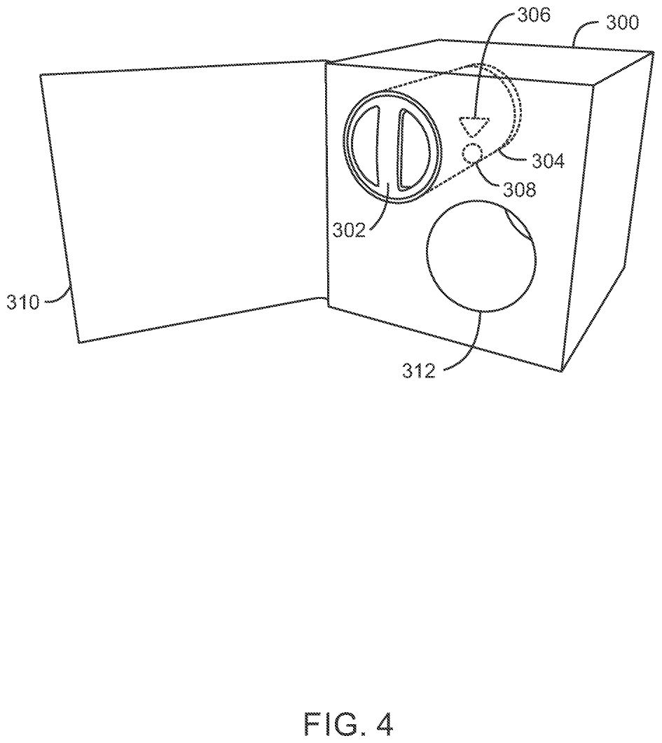

FIG. 4 is a diagram of a 3D printer 300. Like numbered items are the same as their counterparts in FIG. 3. The energy source 308 may be located in the first slot 304 instead of inside the front 310 of the 3D printer 300 as in FIG. 3. When the new material in material cartridge 302 is depleted, the energy source 308 may be activated. Once the energy source 308 is activated, the indicator colorant on a portion or the entirety of the body of the material cartridge 302 may become visible. The change of the indicator colorant from the invisible state to the visible state may be irreversible. Once visible, the colorant may indicate that the material cartridge 302 is depleted of new material and is designated to receive recycled material.

In FIGS. 3 and 4, one energy source 308 is shown. The number of energy sources 308 may not be limited to one. Multiple energy sources 308 may be located proximate the material cartridge 302 installed in the slot 304. In some examples, the energy source 308 may be located inside the front 310 of the 3D printer 300 as shown in FIG. 3 and inside the first slot 302 as shown in FIG. 4.

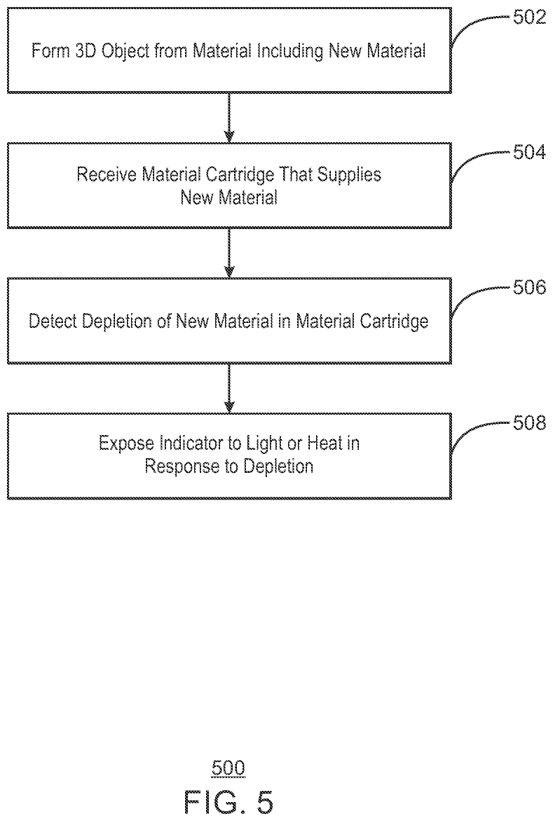

FIG. 5 is a block flow diagram of an example method 500 of operating a 3D printer that receives a material cartridge. At block 502, the method includes forming, via a build platform, a 3D object from material including new material. The new material may include powder that is plastic, polymer, metal, ceramic, or glass, or any combinations thereof. The forming of the 3D object may include forming the 3D object layer-by-layer on the build platform.

At block 504, the method includes receiving, in a cartridge receiver of the 3D printer, a material cartridge that provides for the new material. The new material may be made available to the build platform or to a build enclosure associated with the build platform. The material cartridge has an indicator on an exterior or interior surface of the material cartridge. The indicator may include a colorant (e.g., ink, pigment, etc.) sensitive to energy (e.g., light, heat, etc.) provided by an energy source of the printer. In some examples, the indicator becomes visible in response to exposure of the colorant to the energy. The change of the indicator from the invisible state to the visible state may be irreversible. The indicator may be text or symbols that indicate that the material cartridge is depleted of new material and is designated to receive recycled material.

At block 506, the method includes detecting depletion of the new material in the material cartridge. The detection of the depletion may involve detecting the depletion via a sensor (e.g., a load cell) or correlative with a rate of new material discharging from the material cartridge, or both. Other detection techniques are applicable.

At block 508, the method includes exposing, via the energy source of the 3D printer, the indicator to energy from the energy source in response to the depletion. The energy source may be a light source or a heat source, or both. Therefore, the energy may be light or heat, or both. In a particular example, the energy source is a light source that is a light emitting diode (LED), and the energy is ultraviolet light.

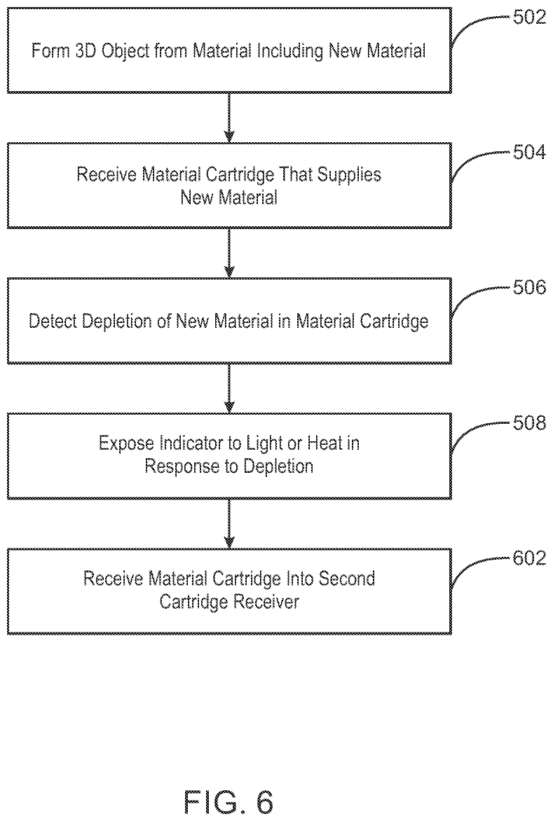

FIG. 6 is a block flow diagram of an example method 600 of operating a 3D printer that receives a material cartridge. Blocks 502-508 are the same as their counterparts in FIG. 5. The material cartridge as depleted may be removed from the first material cartridge receiver. At block 602, the method includes the 3D printer receiving the material cartridge into a second cartridge receiver of the 3D printer after the material cartridge is depleted of new material. In some examples, the method may include receiving recycled material into the material cartridge installed in the second cartridge receiver, such as from a build enclosure of the 3D printer. The method may also include discharging recycled material from the material cartridge in the second cartridge receiver to make available recycled material for supply to the build platform or the build enclosure. Recycled material may be material left over or otherwise unused during the printing of a 3D object. Again, the material cartridge in the second slot may also discharge recycled material. The discharged recycled material may be provided to the build enclosure for use in forming the 3D object. An indicator visible on the material cartridge may indicate that the material cartridge contains recycled material.

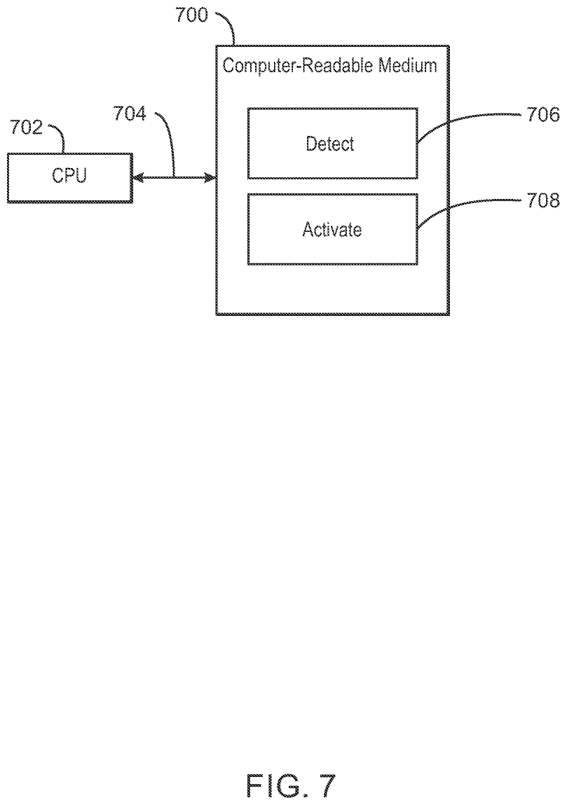

FIG. 7 is a block diagram of a computer-readable medium 700 that may contain code to execute the processing of a 3D printer material cartridge. The medium may be a non-transitory computer-readable medium 700 that stores code that can be accessed by a processor 702 via a bus 704. For example, the computer-readable medium 700 may be a volatile or non-volatile data storage device. The medium 700 may also be a logic unit, such as an application-specific integrated circuit (ASIC), a field-programmable gate array (FPGA), or an arrangement of logic gates implemented in one or more integrated circuits.

The medium 700 may store modules or code (e.g., instructions, logic, etc.) executable to facilitate the techniques described herein. For example, a detect module 706 may be configured to detect when a material cartridge is depleted of new material. The detect module 706 may determine that depletion has occurred when a sensor indicates that the cartridge is depleted. For an example of the sensor as a load cell, the detect module 706 may register the weight as the weight of the empty cartridge and, therefore, determine that the cartridge is depleted. The rate of discharge of new material from the material cartridge may also be used via the detect module to determine if depletion has occurred. Both the weight cell and the discharge rate may be used by the detect module 706 to ascertain when depletion has taken place.

An activate module 708 may be configured to turn on the energy source(s) inside the 3D printer when the material in the material cartridge is depleted. Once the energy source is turned on, the text or symbols printed on or in the material cartridge may become visible. The visible text or symbols may indicate that the material cartridge is designated to receive recycled material.

Therefore, an example of a non-transitory, computer readable medium for a 3D printer incudes machine-readable instructions, that when executed, direct a processor to detect depletion of new material in a material cartridge in the 3D printer. The material cartridge has an indicator. The indicator may be disposed on an external or internal surface of the material cartridge. The 3D printer forms, via a build platform, a 3D object from material including the new material. In some examples, the instructions when executed may direct the processor to detect the depletion via a sensor or based on a rate of new material discharging from the material cartridge, or both. Lastly, the instructions when executed direct the processor to activate a light source or heat source of the 3D printer in response to the depletion to expose the indicator to light or heat, or both.

Some examples of a method of processing a material cartridge may involve inserting the cartridge containing new material into a first slot of a 3D printer. When the cartridge is depleted of new material, the empty cartridge may be removed from the first slot and discarded, stored, or inserted into a second slot of the 3D printer. Once inserted into the second slot, the empty cartridge may be designated to receive recycled material. The user or 3D printer may implement switching of the material cartridge from the first slot to the second slot when the sensor (e.g., load cell) and/or the discharge rate of new material indicate that the material cartridge is empty.

In summary, an example is a 3D printer that employs a material cartridge. The 3D printer may include a cartridge receiver to receive a material cartridge containing new material. The material cartridge may include an indicator on an external or internal surface of the material cartridge. The 3D printer may include an energy source located to expose the indicator to energy in response to depletion of new material in the material cartridge. A controller may detect the depletion of the material cartridge and operate the energy source in response to the depletion. Input to the controller may be the weight of the material cartridge registered by a load cell or the rate of discharge of new material from the material cartridge. The controller may turn on the energy source when the load cell registers substantially zero or the weight of the empty material cartridge, the rate of withdrawal of new material indicates the material cartridge is empty, or both. The 3D printer may include a second cartridge receiver for receiving the material cartridge after the material cartridge is depleted of new material. In the second cartridge receiver, the material cartridge may be designated to receive recycled material from the build enclosure of the 3D printer and/or provide recycled material to the build enclosure.

Certain examples of the techniques discussed herein may result in the use of fewer machines (e.g., a single machine) for 3D printing as compared to the use of several machines with existing 3D printers. Existing 3D printers may use large, expensive, dedicated machines for storing, processing, and offloading recycled powdered material. Because of some examples of the present techniques, the handling of recycled powdered material may be contained and, therefore, generally cleaner. Furthermore, in certain examples, user employment of the material cartridges discussed herein may entail less expertise and less intervention by the user.

In some examples described herein, the same material supply is used first as a new supply and then re-purposed as a recycled supply. The recycled supply is used to load recycled material into the system when there is a recycled material deficit in the printer system and offload recycled material from the system when there is a recycled material surplus. Empty new material cartridges, e.g., recycled material cartridges, should be kept for a period of time. Empty recycled and full recycled material cartridges will ultimately be discarded as appropriate. Material cartridges are specific to a single material type and cannot be mixed with or re-purposed for another material. Some material cartridges may be refillable using the 3D printer discussed herein. Other material cartridges may be refilled employing, for example, an accessory machine, and the like.

While the present techniques may be susceptible to various modifications and alternative forms, the examples discussed above have been shown by way of example. It is to be understood that the techniques are not intended to be limited to the particular examples disclosed herein. Indeed, the present techniques include all alternatives, modifications, and equivalents falling within the scope of the present techniques.

What is claimed is:

1. A three-dimensional (3D) printer comprising:
a cartridge receiver to receive a material cartridge containing new material for generation of a 3D object; and
an energy source disposed to expose an indicator on the material cartridge to energy in response to depletion of new material in the material cartridge to change the appearance of the indicator, wherein the changed appearance of the indicator is to indicate that the material cartridge no longer contains new material.

2. The 3D printer of claim 1, comprising a controller to detect the depletion and operate the energy source to expose the indicator to energy in response to the depletion.

3. The 3D printer of claim 2, comprising a build surface, wherein the 3D printer in generating the 3D object to form the 3D object via the build surface from material comprising the new material, wherein the energy source comprises a light source or heat source, or both, and wherein the controller is to detect the depletion via a sensor or by calculating depletion based on material discharge rate data, or a combination thereof.

4. The 3D printer of claim 1, wherein the 3D printer to form the 3D object layer-by-layer, and wherein the new material comprises powder comprising plastic, polymer, metal, ceramic, or glass, or any combination thereof.

5. The 3D printer of claim 1, comprising a build enclosure associated with the build surface, wherein the build surface comprises a build platform, and wherein the 3D printer to detect the depletion of the new material in the material cartridge based at least in part on a rate of new material discharging from the material cartridge.

6. The 3D printer of claim 1, comprising a sensor to detect depletion of the new material in the material cartridge, wherein the 3D printer is to operate the energy source to expose the indicator to energy in response to the depletion, and wherein the energy source is disposed on a door of the 3D printer or in the cartridge receiver.

7. The 3D printer of claim 6, wherein the sensor comprises a load cell, wherein the cartridge receiver comprises a cavity, receptacle, sleeve, or any combination thereof, and wherein the energy source comprises a light emitting diode (LED), a halogen light, a fluorescent light, or a mercury-arc light, or any combination thereof.

8. The 3D printer of claim 1, comprising a second cartridge receiver to receive the material cartridge after the material cartridge is depleted of the new material, wherein the energy source comprises a light source comprising an LED, and wherein the energy comprises ultraviolet light.

9. A method of operating a three-dimensional (3D) printer, comprising:
forming, via a build platform, a 3D object from material comprising new material;
receiving, in a cartridge receiver of the 3D printer, a material cartridge that provides the new material, wherein the material cartridge comprises an indicator;
detecting depletion of the new material in the material cartridge; and
exposing, via an energy source of the 3D printer, the indicator to energy from the energy source in response to the depletion to change the appearance of the indicator.

10. The method of claim 9, wherein the indicator comprises colorant sensitive to the energy, and wherein the indicator becomes visible in response to exposure of the colorant to the energy.

11. The method of claim 10, wherein the energy source comprises a light source or a heat source, or both, wherein the energy comprises light or heat, or both, wherein the colorant comprises ink, wherein forming the 3D object comprises forming the 3D object layer-by-layer on the build platform, and wherein the new material comprises plastic, polymer, metal, ceramic, or glass, or any combination thereof.

12. The method of claim 9, wherein detecting the depletion comprises detecting the depletion via a sensor or correlative with a rate of new material discharging from the material cartridge, or both.

13. The method of claim 9, comprising:
receiving the material cartridge into a second cartridge receiver of the 3D printer after the material cartridge is depleted of new material; and
receiving a recycled material into the material cartridge in the second cartridge receiver and discharging recycled material from the material cartridge in the second cartridge receiver, wherein the energy source comprises a light source comprising a light emitting diode (LED), and wherein the energy comprises light comprising ultraviolet light.

14. A non-transitory, computer readable medium comprising machine-readable instructions for a three-dimensional (3D) printer, the instructions, when executed, direct a processor to:
detect depletion of new material in a material cartridge in the 3D printer, the material cartridge comprising an indicator, wherein the 3D printer to form, via a build platform, a 3D object from material comprising the new material; and
activate a light source or heat source of the 3D printer in response to the depletion to expose the indicator to light or heat, or both.

15. The non-transitory, computer readable medium of claim 14, wherein the instructions when executed direct the processor to detect the depletion via a sensor or based on a rate of new material discharging from the material cartridge, or both, and wherein the indicator is disposed on an external surface of the material cartridge.
